(19) United States
(12) Patent Application Publication
(10) Pub. No.: US 2006/0177712 A1
(43) Pub. Date: Aug. 10, 2006

(54) Fuel cell unit

(76) Inventor: Tomohiro Hirayama, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/283,562

(22) Filed: Nov. 18, 2005

(30) Foreign Application Priority Data
Feb. 7, 2005 (JP) 2005-030528

(51) Int. Cl. H01M 8/04

(52) U.S. Cl. 429/26; 429/34

(57) ABSTRACT

A fuel cell unit includes a fuel cell, a cooling section which cools a fluid discharged from the fuel cell, a mixing tank which mixes the cooled discharged fluid with fuel into a fuel aqueous solution to be supplied to the fuel cell, and a metal ion elimination filter provided in a flow path extending from the cooling section to the fuel cell through the mixing tank.

### CROSS-REFERENCE TO RELATED APPLICATIONS

This application is based upon and claims the benefit of priority from prior Japanese Patent Application No. 2005-030528, filed Feb. 7, 2005, the entire contents of which are incorporated herein by reference.

### BACKGROUND

1. Field

The present invention relates to a fuel cell usable as a power source for an electronic device or the like.

2. Description of the Related Art

In general, secondary batteries such as lithium-ion batteries are used mainly as power supplies for electronic devices such as a portable notebook personal computer and a mobile device. Recently, the electronic devices have increased in power consumption as their performance becomes high. Further, a longer battery life is required for the devices. To meet this requirement, high-power, small-sized fuel cells that need not be charged is expected as new power supplies. There are fuel cells of various types. In particular, a direct methanol fuel cell using a methanol solution as fuel (referred to as DMFC hereinafter) is noted as a power supply of an electronic device because its fuel is easier to handle and its system is simpler than that of a fuel cell using hydrogen as fuel.

The DMFC is disclosed in Hironosuke Ikeda, “Outline of Fuel Cell,” Nippon Jitsugyo Publishing Co., Ltd., Aug. 20, 2001, pp. 216-217.

A DMFC adopting a dilution circulating system is also known. In the dilution circulating system, a low-concentration methanol aqueous solution is used as fuel to be supplied to a DMFC stack. This system includes a mixing tank in which high-concentration methanol is diluted with water and a cooling section which cools fluids (methanol aqueous solution, water vapor) discharged from the DMFC stack. The cooled discharged fluids are returned to the mixing tank and reused to generate a low-concentration methanol aqueous solution.

In the dilution circulating system, it is likely that a very small number of metal ions included in the methanol aqueous solution will inhibit chemical reaction in the DMFC stack and thus decrease the power generation efficiency of the DMFC stack.

The metal ions included in the methanol aqueous solution are not only ones originally contained in methanol which is fuel, but also ones generated from a pipe that forms a circulating flow path, a DMFC stack, other components in the circulating flow path, and the like. During the operation of the system, therefore, new metal ions are generated one after another and emitted into a methanol aqueous solution.

Consequently, a new function needs to be achieved in order to inhibit a decrease in power generation efficiency due to the flow of metal ions into a fuel cell.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exemplary external view of a fuel cell unit according to an embodiment of the present invention;

FIG. 2 is an exemplary external view of the fuel cell unit shown in FIG. 1, to which an information processing apparatus is connected;

FIG. 3 is an exemplary block diagram depicting a configuration of the fuel cell unit shown in FIG. 1;

FIG. 4 is an exemplary illustration of an example of the arrangement of components in the fuel cell unit shown in FIG. 1; and

FIG. 5 is a exemplary graph of characteristics of a metal ion elimination filter applied to the fuel cell unit shown in FIG. 1.

### DETAILED DESCRIPTION

An embodiment according to the present invention will be described below with reference to the accompanying drawings.

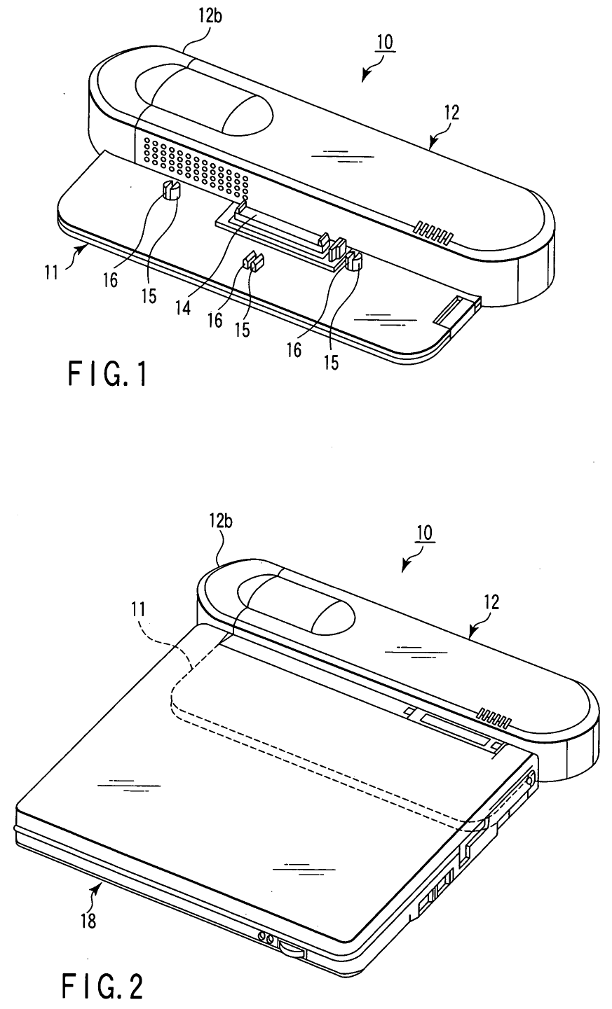

FIG. 1 is an external view of a fuel cell unit 10 according to an embodiment of the present invention. The fuel cell unit 10 is configured as a DMFC using methanol as liquid fuel. Further, the fuel cell unit 10 can be configured as a power supply of an electronic device such as a personal computer.

The fuel cell unit 10 comprises a fuel cell unit main body 12 and a mounting unit 11 extended from the main body 12. The mounting unit 11 is flat and rectangular. As shown in FIG. 2, the rear portion of an information processing apparatus 18 such as a personal computer can be mounted on the mounting unit 11. The main body 12 includes a DMFC stack that generates power by chemical reaction and an auxiliary machine (pump, bulb, etc.) that injects methanol into the DMFC stack as fuel and circulates it therein.

A detachable fuel cartridge (not shown) is provided at, for example, the inner left end of the main body 12. A cover 12b is provided detachably from the main body 12 to exchange the fuel cartridge.

A docking connector 14 is provided on the top surface of the mounting unit 11 as a connection unit for connecting the mounting unit 11 to the information processing apparatus 18. Three combinations of a positioning projection 15 and a hook 16 are provided on the mounting unit 11. These combinations are inserted into their corresponding three holes in the rear bottom of the information processing apparatus 18 when the rear portion of the apparatus 18 is mounted on the mounting unit 11 as shown in FIG. 2.

The fuel cell unit 10 shown in FIGS. 1 and 2 can be varied in shape and size, and the docking connector 14 can be varied in shape and position.

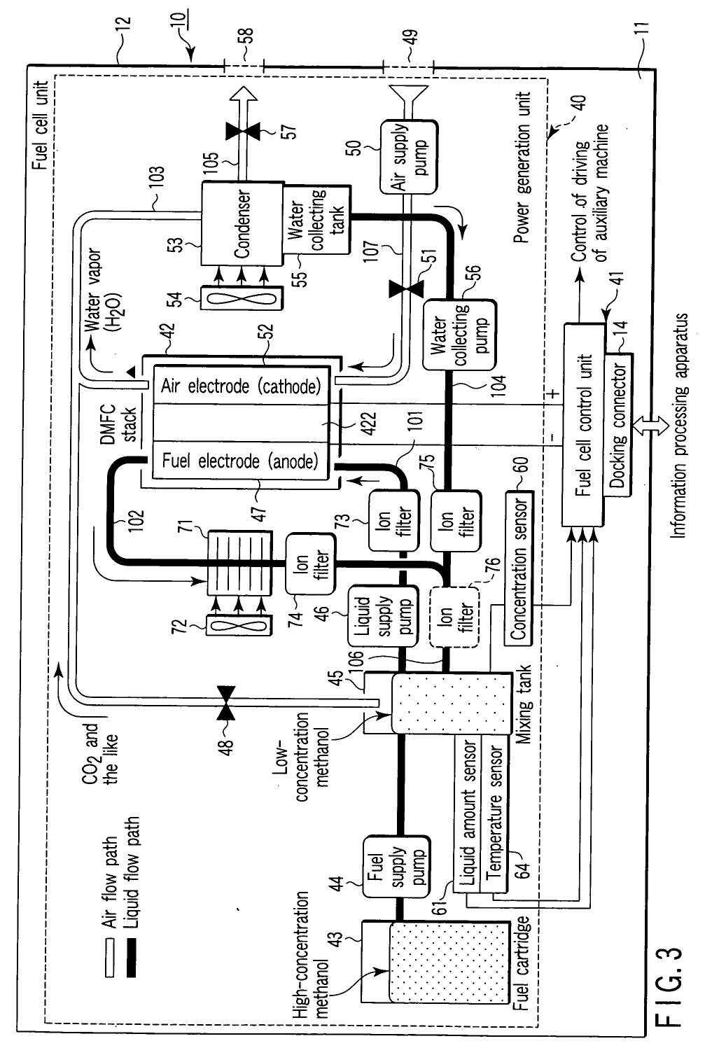

The internal configuration of the fuel cell unit 10 will be described with reference to FIG. 3.

The fuel cell unit 10 includes a power generation unit 40 and a fuel cell control unit 41. The fuel cell control unit 41 not only controls the power generation unit 40, but also serves as a communication control unit that communicates with the information processing apparatus 18. The power generation unit 40 is provided in the fuel cell unit main body 12 and the fuel cell control unit 41 is provided in the mounting unit 11.

The power generation unit 40 has a DMFC stack 42 and a fuel cartridge 43. The DMFC stack 42 is a fuel cell serving as an electromotive unit that generates power by chemical reaction. This power generating operation causes the DMFC stack 42 to generate heat. In order to prevent the heat from being transmitted to the components formed around the DMFC stack 42, the outer or inner surface of the housing of the DMFC stack 42 is coated with heat insulation materials. A high-concentration methanol solution is sealed in the fuel cartridge 43.

In the DMFC, generally, a crossover phenomenon has to be lessened in order to increase power generation efficiency. It is thus effective to dilute the high-concentration methanol to lower its concentration and then inject it into an anode (fuel electrode) 47 of the DMFC stack 42. To achieve this, the fuel cell unit 10 adopts a dilution circulating system. The dilution circulating system includes a flow path that is roughly divided into a liquid flow path and an air flow path.

First, a relationship in coupling between components provided in the liquid flow path will be described. A fuel supply pump 44 is coupled to the output of the fuel cartridge 43 through a pipe. The output of the fuel supply pump 44 is coupled to a mixing tank 45 through a pipe. The output of the mixing tank 45 is coupled to the input of an anode (fuel electrode) 47 of the DMFC stack 42 through a pipe 101. The pipe 101 is used as a flow path through which a methanol aqueous solution is supplied to the DMFC stack 42 from the mixing tank 45.

The pipe 101 includes a liquid supply pump 46 and a metal ion elimination filter (ion filter) 73. The output of the mixing tank 45 is coupled to the anode 47 through the liquid supply pump 46 and the metal ion elimination filter 73. The filter 73 uses an ion exchanger to adsorb metal ions included in a methanol aqueous solution that is sent to the DMFC stack 42 from the mixing tank 45 through the pipe 101, thereby eliminating the metal ions from the methanol aqueous solution.

A pipe 106 extends from the input of the mixing tank 45 and branches into two pipes 102 and 104. The pipe 102 is a flow path for returning a fluid discharged from the anode 47 of the DMFC stack 42, or a methanol aqueous solution not used for chemical reaction (an unreacted methanol aqueous solution) to the mixing tank 45. The pipe 102 is coupled to the output of the anode 47 of the DMFC stack 42. A number of radiating fins 71 are provided around the pipe 102. The radiating fins 71 serve as an anode cooling section that cools the methanol aqueous solution discharged from the anode 47. A cooling fan 72 is provided close to the radiating fins 71. The temperature of the methanol aqueous solution discharged from the anode 47 is, for example, 60° C. or higher. This temperature drops to, for example, about 45° C. to 50° C. when the methanol aqueous solution passes through the radiating fans 71.

The pipe 102 includes a metal ion elimination filter 74. This filter 74 also uses an ion exchanger to adsorb metal ions included in a methanol aqueous solution that is sent to the mixing tank 45 from the DMFC stack 42, thereby eliminating the metal ions from the methanol solution.

The output of a water collecting tank 55 is coupled to the pipe 104 described above. The tank 55 stores water collected from fluids (water vapor) discharged from a cathode (air electrode) 52 of the DMFC stack 42. The pipe 104 includes a water collecting pump 56 and a metal ion elimination filter 75 between the output of the water collecting tank 55 and the input of the mixing tank 45. This filter 75 also uses an ion exchanger to adsorb metal ions included in water (containing methanol components moved to the cathode 52 by a crossover phenomenon) which is sent to the mixing tank 45 from the water collecting tank 55, thereby eliminating the metal ions from the water.

Then, a relationship in coupling between components provided in the air flow path will be described. An air supply pump 50 is coupled to the input of the cathode (air electrode) 52 of the DMFC stack 42 through a pipe 107 in which an air supply valve 51 is inserted. The output of the cathode 52 is connected to a condenser 53 through a pipe 103. The condenser 53 serves as a cathode cooling section for cooling fluids (water vapor, water) discharged from the output of the cathode 52. The condenser 53 includes a number of radiating fins provided around the pipe 103. A cooling fan 54 is provided close to the radiating fins. The condenser 53 cools the fluids, so that the water vapor is coagulated and the temperature of water discharged from the output of the cathode 52 is lowered. Thus, the temperature of water flowing from the water collecting tank 55 through the pipe 104 is about 45° C. to 50° C.

The mixing tank 45 is connected to the condenser 53 through a mixing tank valve 48 and pipe 103. The condenser 53 is connected to an exhaust hole 58 through a pipe 105 and an exhaust valve 57.

As described above, the fuel cell unit 10 includes the radiating fins 71 and condenser 53 as cooling sections for cooling the fluids (low-concentration methanol, water vapor) discharged from the DMFC stack 42. The metal ion elimination filters 73, 74 and 75 are arranged in the flow path that extends from the cooling sections to the anode 47 of the DMFC stack 42 via the mixing tank 45.

In the fuel cell unit 10, it is likely that metal ions will be generated from the DMFC stack 42 by chemical reaction or one of the pipes, etc. The portion of each of the pipes which passes through the cooling sections is usually made of metal to increase heat radiation efficiency. There is a strong possibility that metal ions will be generated from these metal portions. There is a case where the high-concentration methanol in the fuel cartridge 43 originally contains metal ions. If low-concentration methanol containing metal ions is supplied to the anode 47 of the DMFC stack 42, the DMFC stack 42 decreases in power generation efficiency.

According to the present embodiment, the metal ion elimination filter 73 is provided immediately before the anode 47 of the DMFC stack 42. Even though metal ions are generated during the operation of the system, they can efficiently be prevented from being supplied to the anode 47. The metal ion elimination filters 74 and 75 can prevent metal ions included in discharged fluids from flowing into the mixing tank 45.

In general, the metal ion elimination filters are influenced by liquid temperatures and ambient temperatures, and their ion elimination efficiency decreases as these temperatures increase. It is thus favorable that the metal ion elimination filters be used at room temperatures. The radiating fins 71, which are the cooling section on the anode side, and the condenser 53, which is the cooling section on the cathode side, can decrease the discharged fluids flowing into the mixing tank 45 to a relatively low temperature ranging from 45° C. to 50° C. The low-concentration methanol aqueous solution supplied from the mixing tank 45 to the anode 47 is also set to a relatively low temperature ranging from 45° C. to 50° C. Consequently, the metal ion elimination filter 73 provided between the mixing tank 45 and the anode 47 can operate at relative low temperatures. Since the DMFC stack 42 is coated with heat insulation materials as described above, the metal ion elimination filter 73 is not influenced by heat from the DMFC stack 42. Since the metal ion elimination filter 73 is provided between the liquid supply pump 46 and the anode 47, it fulfills a function of capturing soil of the pump 46. It is thus possible to prevent dust included in a methanol aqueous solution that is pressure-supplied from the pump 46 from flowing into the anode 47, with the result that high power generation efficiency of the DMFC stack 42 can be maintained.

Since the low-concentration methanol flowing into the metal ion elimination filter 74 and the water flowing into the metal ion elimination filter 75 are cooled by the cooling sections 71 and 53, respectively, these filters 74 and 75 can perform their filtering operations sufficiently.

In the present embodiment, the three metal ion elimination filters 73, 74 and 75 are provided; however, only the filter 73 can bring sufficiently practical advantages. Instead of the filter 73, only two filters 74 and 75 can be used. Instead of the filter 73, only one of the filters 74 and 75 can be used. Instead of two filters 74 and 75, a metal ion elimination filter 76 can be provided in the pipe 106. The filter 76 can perform both the functions of the filters 74 and 75.

In short, basically, at least one metal ion elimination filter has only to be provided in a path extending from a cooling section, which cools discharged fluids such as unreacted methanol and water vapor, to the DMFC stack 42 through the mixing tank 45.

A power generating operation of the fuel cell unit 10 will be described.

High-concentration methanol in the fuel cartridge 43 is caused to flow into the mixing tank 45 by the fuel supply pump 44. In the mixing tank 45, the high-concentration methanol is mixed and diluted with water collected from water vapor discharged from the cathode 52 and low-concentration methanol (unreacted methanol) discharged from the anode 47, thereby a low-concentration methanol aqueous solution that is to be supplied to the DMFC stack 42 as a fuel solution is generated. Since the fluids (low-concentration methanol, water vapor, etc.) discharged from the DMFC stack 42 are returned to the mixing tank 45, the mixing tank 45 can reuse the discharged fluids for generating a low-concentration methanol aqueous solution.

The concentration of the low-concentration methanol solution generated in the mixing tank 45 is controlled to remain at such a concentration (e.g., 3% to 6%) as to increase power generation efficiency. This control of concentration is achieved by the fuel cell control unit 41 to control the amount of high-concentration methanol supplied to the mixing tank 45 by the fuel supply pump 44 based on the sensing results of a concentration sensor 60, or by controlling an amount of water returned to the mixing tank 45.

The mixing tank 45 includes a liquid amount sensor 61 for sensing an amount of methanol aqueous solution in the tank 45 and a temperature sensor 64 for sensing temperatures. The sensing results of these sensors are sent to the fuel cell control unit 41 and used for controlling the power generation unit 40.

The methanol aqueous solution diluted in the mixing tank 45 is pressure-supplied to the anode 47 from the liquid supply pump 46 through the metal ion elimination filter 73. The filter 73 eliminates metal ions from the methanol aqueous solution. The anode 47 generates electrons by oxidation reaction of methanol. The oxidation reaction generates hydrogen ions (H+), and the hydrogen ions reach the cathode 52 through a solid polyelectrolyte film 422.

The oxidation reaction also generates carbon dioxide. On one hand, the carbon dioxide circulates again into the mixing tank 45 together with an unreacted methanol solution. The methanol aqueous solution discharged from the anode 47 is cooled by the cooling section 71 and supplied to the mixing tank 45 through the metal ion elimination filter 74. The carbon dioxide is vaporized in the mixing tank 45, supplied to the condenser 53 through the mixing tank valve 48, and finally exhausted from the exhaust hole 58 through the exhaust valve 57.

On the other hand, air (oxygen) is taken in through an air intake 49, pressurized by the air supply pump 50 and injected into the cathode (air electrode) 52 through the air supply valve 51. In the cathode 52, the reductive reaction of oxygen (O₂) progresses, and water (H2O) is generated as water vapor from electrons (e−) from an external load, hydrogen ions (H+) and oxygen (O₂). This water vapor is discharged from the cathode 52 and supplied to the condenser 53. In the condenser 53, the water vapor is cooled into water (liquid) by the cooling fan 54 and stored temporarily in the water collecting tank 55. The collected water is returned to the mixing tank 45 through the metal ion elimination filter 75 by the water collecting pump 56. The filter 75 eliminates metal ions from the water.

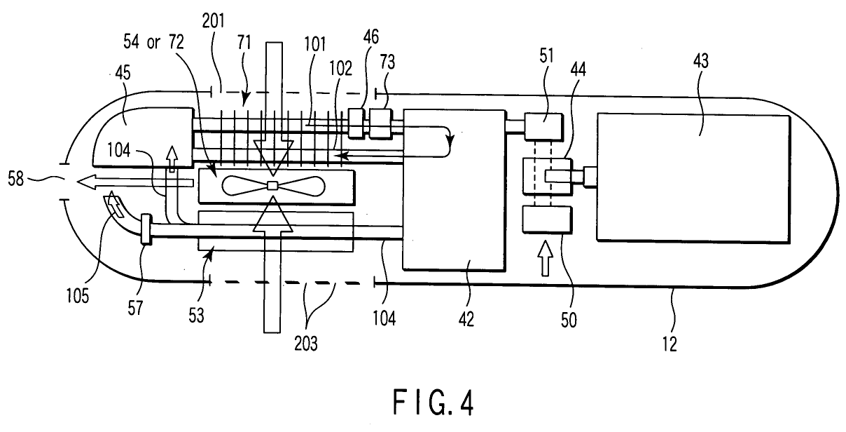

FIG. 4 illustrates an example of the arrangement of components in the fuel cell unit 10.

FIG. 4 is a top view of the internal structure of the fuel cell unit main body 12. The fuel cartridge 43 is provided at one end of the main body 12, while the mixing tank 45 is provided at the other end thereof. The DMFC stack 42 is arranged in the middle of the main body 12. Between the DMFC stack 42 and the fuel cartridge 43, the fuel supply pump 44, air supply pump 50 and air supply valve 51 are arranged as shown in FIG. 4.

The above two pipes 101 and 102 are arranged between the mixing tank 45 and the DMFC stack 42 as circulating flow paths for circulating a methanol aqueous solution between the tank 45 and the stack 42. The liquid supply pump 46 and the metal ion elimination filter 73 are inserted into the pipe 101. The radiating fins 71 are provided around the pipe 102 so as to extend in a direction perpendicular to the longitudinal direction of the pipe 102.

The pipe 104 is also provided between the mixing tank 45 and the DMFC stack 42. The condenser 53 is connected to the pipe 104. As has been described with reference to FIG. 3, the pipe extending from the input of the mixing tank 45 can be configured to branch into two pipes 102 and 104.

A pipe 105 extends in parallel with the pipe 104. One cooling fan serving as both the two cooling fans 54 and 72 is provided between the pipes 102 and 104. When the cooling fan is driven, air is guided into the main body 12 through vents 201 and 203. The air guided through the vent 201 cools the radiating fins 71 therethrough and then exhausted from the exhaust hole 58. The air guided through the vent 203 cools the fins in the condenser 53 and then is exhausted from the exhaust hole 58.

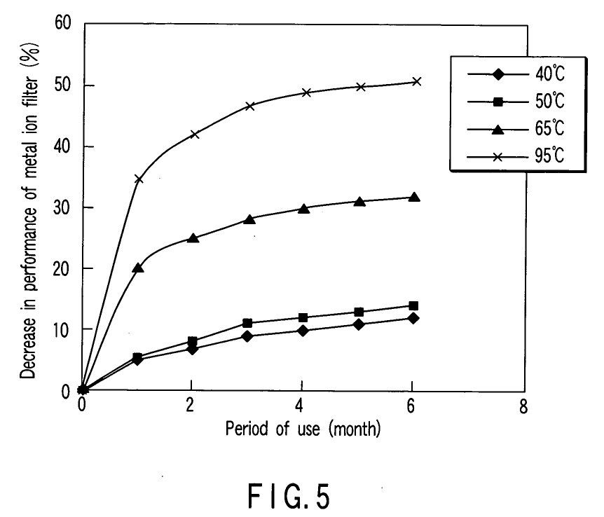

FIG. 5 is a graph of characteristics of the metal ion elimination filter, which shows the percentage of decrease in the performance of the filter for each of the temperatures of liquids passing through the filter.

As is seen from FIG. 5, when the temperature is 40° C. or 50° C., the percentage of decrease in the performance is only about 10% for six-month use of the filter. When the temperature is 65° C., the percentage decreases by about 20% for only one-month use of the filter. When the temperature is 95° C., the percentage decreases by about 35% for only one-month use of the filter.

It is also seen from FIG. 5 that the performance of the metal ion elimination filter is prevented from decreasing when the temperature of liquids is lower. A necessary condition is therefore that the metal ion elimination filters should be used when the temperature of the liquids are low.

In the embodiment of the present invention, the metal ion elimination filters are provided in low-temperature sections in the fuel cell unit and thus their performance can be maintained for a long period of time. Since the filter is provided after the liquid supply pump (or immediately before the stack), the filter can serve to capture soil of the pump. Consequently, the efficiency of power generation can be inhibited from decreasing due to metal ions and thus increased adequately.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fuel cell unit comprising:
a fuel cell;
a cooling section which cools a fluid discharged from the fuel cell;
a mixing tank which mixes the cooled discharged fluid with fuel into a fuel aqueous solution to be supplied to the fuel cell; and
a metal ion elimination filter provided in a flow path extending from the cooling section to the fuel cell through the mixing tank.

2. The fuel cell unit according to claim 1, wherein the metal ion elimination filter is provided between the mixing tank and the fuel cell.

3. The fuel cell unit according to claim 2, wherein the fuel cell is coated with heat insulation materials.

4. The fuel cell unit according to claim 1, further comprising a liquid supply pump which pressure-supplies the fuel aqueous solution from the mixing tank to the fuel cell, and
wherein the metal ion elimination filter is provided between the liquid supply pump and the fuel cell.

5. The fuel cell unit according to claim 4, wherein the fuel cell is coated with heat insulation materials.

6. The fuel cell unit according to claim 1, wherein the metal ion elimination filter includes a first metal ion elimination filter which is provided between the cooling section and the mixing tank and a second metal ion elimination filter which is provided between the mixing tank and the fuel cell.

7. The fuel cell unit according to claim 1, wherein the discharged fluid is a fuel aqueous solution discharged from an anode of the fuel cell.

8. The fuel cell unit according to claim 1, wherein the discharged fluid is water vapor discharged from a cathode of the fuel cell.

9. The fuel cell unit according to claim 1, wherein the cooling section is configured to cool a fuel aqueous solution discharged from an anode of the fuel cell.

10. The fuel cell unit according to claim 1, wherein the cooling section is configured to cool water vapor discharged from a cathode of the fuel cell and coagulate the water vapor.

11. The fuel cell unit according to claim 1, wherein the cooling section includes a first cooling section which cools a fuel aqueous solution discharged from an anode of the fuel cell and a second cooling section which cools water vapor discharged from a cathode of the fuel cell and coagulates the water vapor, and
the metal ion elimination filter includes a first metal ion elimination filter which is provided in a flow path extending from the first cooling section to the mixing tank and a second metal ion elimination filter which is provided in a flow path extending from the second cooling section to the mixing tank.

12. The fuel cell unit according to claim 1, further comprising a second flow path and a third flow path into which a first flow path extending from the mixing tank branches and which are coupled to an anode of the fuel cell and a cathode thereof, and
wherein the cooling section includes a first cooling section which is provided in the second flow path to cool a fuel aqueous solution discharged from the anode of the fuel cell and a second cooling section which is provided in the third flow path to cool water vapor discharged from the cathode of the fuel cell and coagulate the water vapor, and
the metal ion elimination filter is provided in the first flow path.
